(19) United States
(12) Patent Application Publication
(10) Pub. No.: US 2008/0101590 A1
(43) Pub. Date: May 1, 2008

(54) Digital DC Feed for a Subscriber Line Interface Circuit

(76) Inventor: Yan Zhou, Austin, TX (US)

Correspondence Address: DAVIS & ASSOCIATES, P.O. BOX 1093, DRIPPING SPRINGS, TX, 78620, US

(21) Appl. No.: 11/552,784

(22) Filed: Oct. 25, 2006

(51) Int. Cl. H04M 1/00; H04M 9/00

(52) U.S. Cl. 379/399.01

(57) ABSTRACT

A subscriber line interface circuit apparatus includes a controller for controlling a DC feed of a subscriber loop in accordance with a first DC feed curve defined by a first set of points in response to sensed subscriber loop signals. A stability compensator is coupled to the subscriber loop. The controller maps the first set of points to a second set of points to define a compensator-adjusted DC feed curve for compensator-affected sensed signals received from the subscriber loop. The controller controls the DC feed in accordance with the compensator-adjusted DC feed curve in response to compensator-affected sensed subscriber loop signals such that the subscriber loop DC feed follows the first DC feed curve.

### FIELD OF THE INVENTION

This invention relates to the field of telecommunications. In particular, this invention is drawn to subscriber line interface circuitry.

### BACKGROUND

Subscriber line interface circuits are typically found in the central office exchange of a telecommunications network. A subscriber line interface circuit (SLIC) provides a communications interface between the digital switching network of a central office and an analog subscriber line. The analog subscriber line connects to a subscriber station or telephone instrument at a location remote from the central office exchange.

The analog subscriber line and subscriber equipment form a subscriber loop. The interface requirements of an SLIC typically result in the need to provide relatively high voltages and currents for control signaling with respect to the subscriber equipment on the subscriber loop. Voiceband communications are typically low voltage analog signals on the subscriber loop. Thus the SLIC must detect and transform low voltage analog signals into digital data for transmitting communications received from the subscriber equipment to the digital network. For bidirectional communication, the SLIC must also transform digital data received from the digital network into low voltage analog signals for transmission on the subscriber loop to the subscriber equipment.

Modern SLIC designs may incorporate one or more specialized integrated circuits including a digital signal processor for controlling the DC feed on the subscriber line. The change between analog and digital domains can result in stability problems for some modes of operation of the SLIC.

### SUMMARY OF THE INVENTION

A subscriber line interface circuit apparatus includes a controller for controlling a DC feed of a subscriber loop in accordance with a first DC feed curve defined by a first set of points in response to sensed subscriber loop signals. A stability compensator is coupled to the subscriber loop. The controller maps the first set of points to a second set of points to define a compensator-adjusted DC feed curve for compensator-affected sensed signals received from the subscriber loop. The controller controls the DC feed in accordance with the compensator-adjusted DC feed curve in response to compensator-affected sensed subscriber loop signals such that the subscriber loop DC feed follows the first DC feed curve.

A method includes receiving parameters identifying a first set of points defining a first DC feed curve for a subscriber loop. The first set of points is mapped to a second set of points defining a compensator-adjusted DC feed curve for the subscriber loop. A stability compensator is applied to the subscriber loop. The subscriber loop DC feed is controlled in accordance with the compensator-adjusted DC feed curve in response to compensator-affected sensed subscriber loop signals such that the subscriber loop DC feed follows the first DC feed curve.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a subscriber line interface circuit including a signal processor and a linefeed driver.

FIG. 2 illustrates one embodiment of a DC feed curve.

FIG. 3 illustrates one embodiment of a SLIC linefeed driver control loop.

FIG. 4 illustrates one embodiment of a SLIC linefeed driver control loop including a stability compensator.

FIG. 5 illustrates a compensator-adjusted DC feed curve.

FIG. 6 illustrates one embodiment of a method of controlling a subscriber loop DC feed.

### DETAILED DESCRIPTION

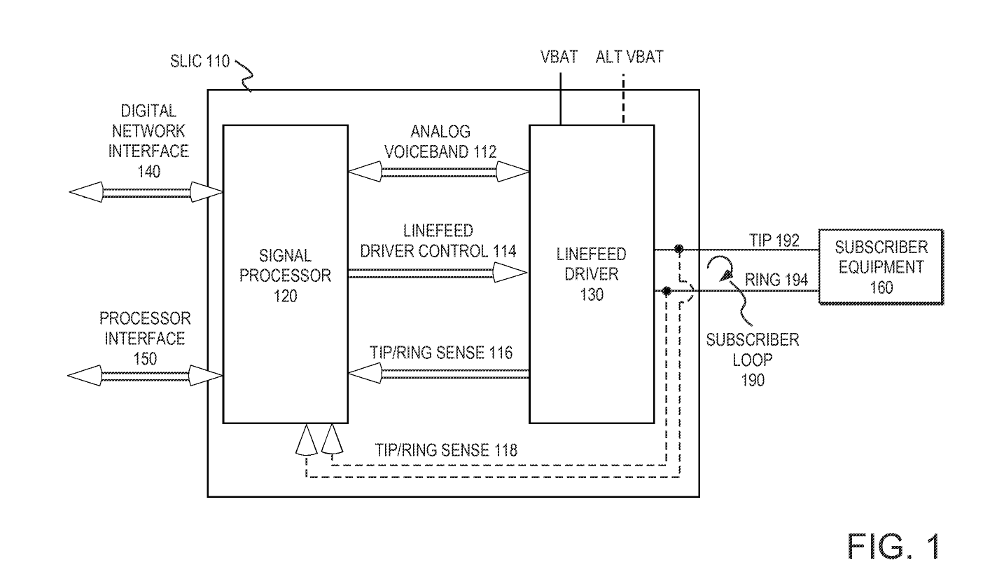

FIG. 1 illustrates one embodiment of a subscriber line interface circuit 110 associated with plain old telephone services (POTS) telephone lines. The subscriber line interface circuit (SLIC) provides an interface between a digital switching network of a local telephone company central exchange and a subscriber line comprising a tip 192 and a ring 194 line. A subscriber loop 190 is formed when the subscriber line is coupled to subscriber equipment 160 such as a telephone.

The subscriber loop 190 communicates analog data signals (e.g., voiceband communications) as well as subscriber loop “handshaking” or control signals. The subscriber loop state is often specified in terms of the tip 192 and ring 194 portions of the subscriber loop.

The SLIC is typically expected to perform a number of functions often collectively referred to as the BORSCHT requirements. BORSCHT is an acronym for “battery feed,” “overvoltage protection,” “ringing,” “supervision,” “codec,” “hybrid,” and “test.” The term “linefeed” will be used interchangeably with “battery feed”. Modern SLICs may have battery backup, but the supply to the subscriber line is typically not actually provided by a battery despite the retention of the term “battery” to describe the supply (e.g., VBAT).

The ringing function, for example, enables the SLIC to signal the subscriber equipment 160. In one embodiment, subscriber equipment 160 is a telephone. Thus, the ringing function enables the SLIC to ring the telephone.

In the illustrated embodiment, the BORSCHT functions are distributed between a signal processor 120 and a linefeed driver 130. The signal processor and linefeed driver typically reside on a linecard (110) to facilitate installation, maintenance, and repair at a central exchange. Signal processor 120 is responsible for at least the ringing control, supervision, codec, and hybrid functions. Signal processor 120 controls and interprets the large signal subscriber loop control signals as well as handling the small signal analog voiceband data and the digital voiceband data.

In one embodiment, signal processor 120 is an integrated circuit. The integrated circuit includes sense inputs for both a sensed tip and a sensed ring signal of the subscriber loop. The integrated circuit generates subscriber loop linefeed driver control signal in response to the sensed signals. The signal processor has relatively low power requirements and can be implemented in a low voltage integrated circuit operating in the range of approximately 5 volts or less. In one embodiment, the signal processor is fabricated as a complementary metal oxide semiconductor (CMOS) integrated circuit.

Signal processor 120 receives subscriber loop state information from linefeed driver 130 as indicated by tip/ring sense 116. The signal processor may alternatively directly sense the tip and ring as indicated by tip/ring sense 118. This information is used to generate linefeed driver control 114 signals for linefeed driver 130. Analog voiceband 112 data is bi-directionally communicated between linefeed driver 130 and signal processor 120. In an alternative embodiment, analog voiceband signals are communicated downstream to the subscriber equipment via the linefeed driver but upstream analog voiceband signals are extracted from the tip/ring sense 118.

SLIC 110 includes a digital network interface 140 for communicating digitized voiceband data to the digital switching network of the public switched telephone network (PSTN). The SLIC may also include a processor interface 150 to enable programmatic control of the signal processor 120. The processor interface effectively enables programmatic or dynamic control of battery control, battery feed state control, voiceband data amplification and level shifting, longitudinal balance, ringing currents, and other subscriber loop control parameters as well as setting thresholds including ring trip detection and off-hook detection threshold.

Linefeed driver 130 maintains responsibility for battery feed to tip 192 and ring 194. The battery feed and supervision circuitry typically operate in the range of 40-75 volts. The battery feed is negative with respect to ground, however. Moreover, although there may be some crossover, the maximum and minimum voltages utilized in the operation of the battery feed and supervision circuitry (˜48 or less to 0 volts) tend to define a range that is substantially distinct from the operational range of the signal processor (e.g., 0-5 volts). In some implementations the ringing function is handled by the same circuitry as the battery feed and supervision circuitry. In other implementations, the ringing function is performed by separate higher voltage ringing circuitry (75-150 Vᵣₘₛ).

Linefeed driver 130 modifies the large signal tip and ring operating conditions in response to linefeed driver control 114 provided by signal processor 120. This arrangement enables the signal processor to perform processing as needed to handle the majority of the BORSCHT functions. For example, the supervisory functions of ring trip, ground key, and off-hook detection can be determined by signal processor 120 based on operating parameters provided by tip/ring sense 116.

The linefeed driver receives a linefeed supply VBAT for driving the subscriber line for SLIC “on-hook” and “off-hook” operational states. An alternate linefeed supply (ALT VBAT) may be provided to handle the higher voltage levels (75-150 Vrms) associated with ringing.

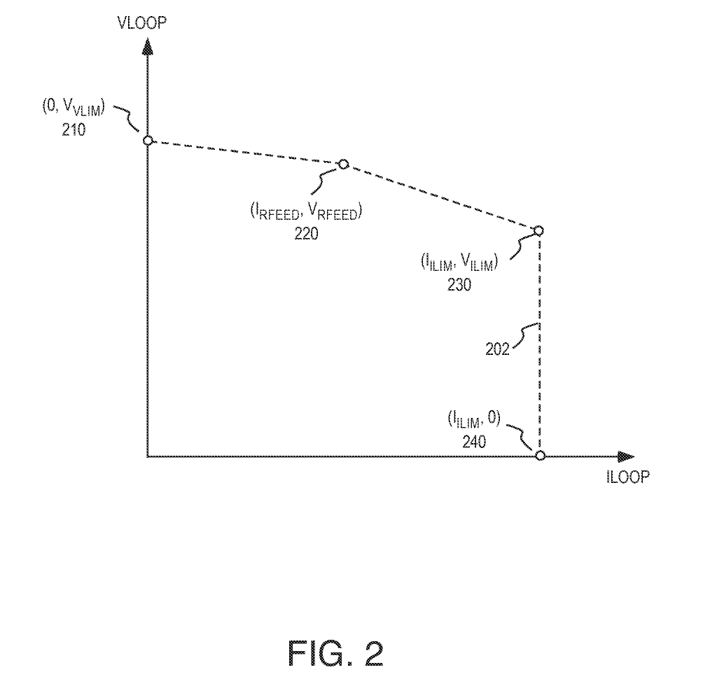

FIG. 2 illustrates one embodiment of a SLIC DC feed curve 202. The term “curve” is not intended to be limited to curvaceous-shaped feed characteristics, but rather is used to describe a collection of points defining a path. Thus, for example, the DC feed curve may be decomposed into piecemeal segments that may be defined by various polynomial functions. One or more segments may be line segments, for example.

The DC feed curve is expressed in terms of loop voltage (V_{LOOP}) and current (I_{LOOP}). The SLIC controls the subscriber loop DC feed to follow the curve. The operating point along the curve is determined by the subscriber loop load. In one embodiment, the curve includes three segments defining three regions of operation: constant voltage, resistive feed, and current limited.

The constant voltage region extends from point 210 to point 220. Point 210 is defined by the co-ordinates (0, V_{VLIM}). The resistive feed region exists between points 220 and 230. Point 220 is defined by the co-ordinate (I_{RFEED}, V_{RFEED}). The current limit region exists between points 230 and 240. The current is not permitted to exceed this limit. Point 230 is defined by the co-ordinates (I_{ILIM}, V_{ILIM}). Point 240 is defined by the co-ordinate (I_{ILIM}, 0). Parameters V_{VLIM}, I_{RFEED}, V_{RFEED}, I_{ILIM}, and V_{ILIM} may be programmable to permit adjustment to accommodate environmental constraints such as the available battery, loop length, or other constraint. These parameters may be provided via the processor interface 150 and stored, for example, within a register or other memory of the signal processor.

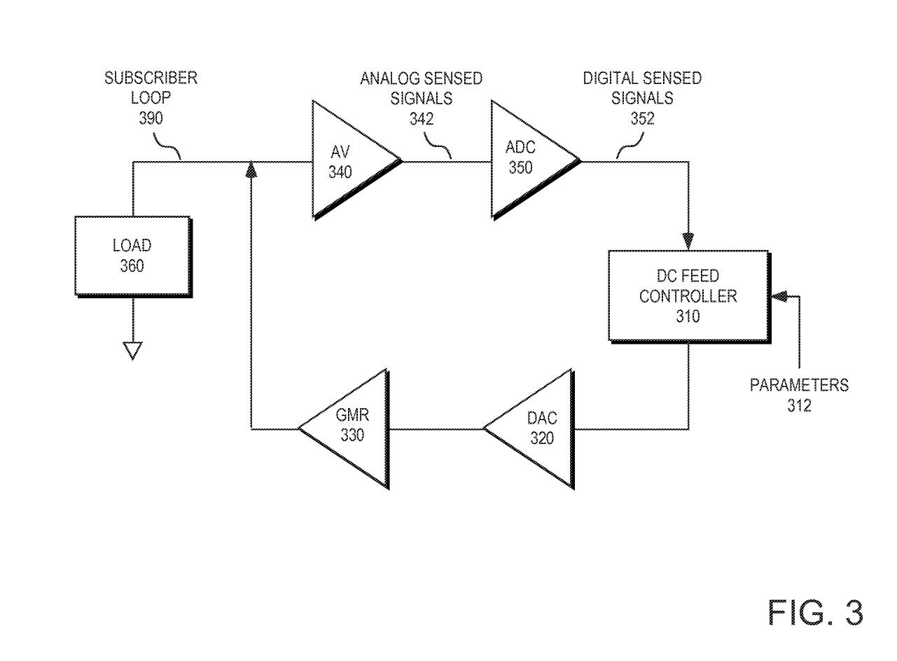

FIG. 3 illustrates one embodiment of a control loop for controlling the DC feed for a subscriber loop. The subscriber loop and control loop are illustrated as a single-ended system for purposes of discussion, however, the system may be embodied as a differential system controlling the feed between tip and ring lines of a differential subscriber loop.

In the illustrated embodiment, the DC control loop is a voltage sense (AV 340), current feed (GMR 330) control loop. The subscriber loop 390 voltage is provided as an analog sensed signal 342 to an analog-to-digital converter (ADC 350) which provides an equivalent digital sensed signal 352 to the DC feed controller 310. In one embodiment, the controller functionality is provided by the signal processor 120 of FIG. 1.

The digital DC feed controller determines the DC feed curve in accordance with the provided parameters 312. In particular, the parameters 312 are used to identify the points defining a DC feed curve as described with respect to FIG. 2. In response to the sensed signals, the controller provides digital control signals indicative of any change required to conform the subscriber loop voltage or current to the defined DC feed curve. The digital control signals are converted to analog form by a digital-to-analog converter (DAC 320) for driving the loop with GMR 330.

Typically, the control loop gain is large. A large control loop gain can be problematic for a load 360 with a high impedance. For example, in on-hook states, the load 360 presented by the subscriber equipment tends to have a high impedance. The combination of large control loop gain can and high subscriber loop impedance can cause de-stabilization of the DC feed control. A small changes to the input of GMR 330 resulting from small changes to control signal provided to the input of DAC 320 can result in large de-stabilizing swings in the loop voltage as a result of the application of GMR 330 to the high impedance load 360.

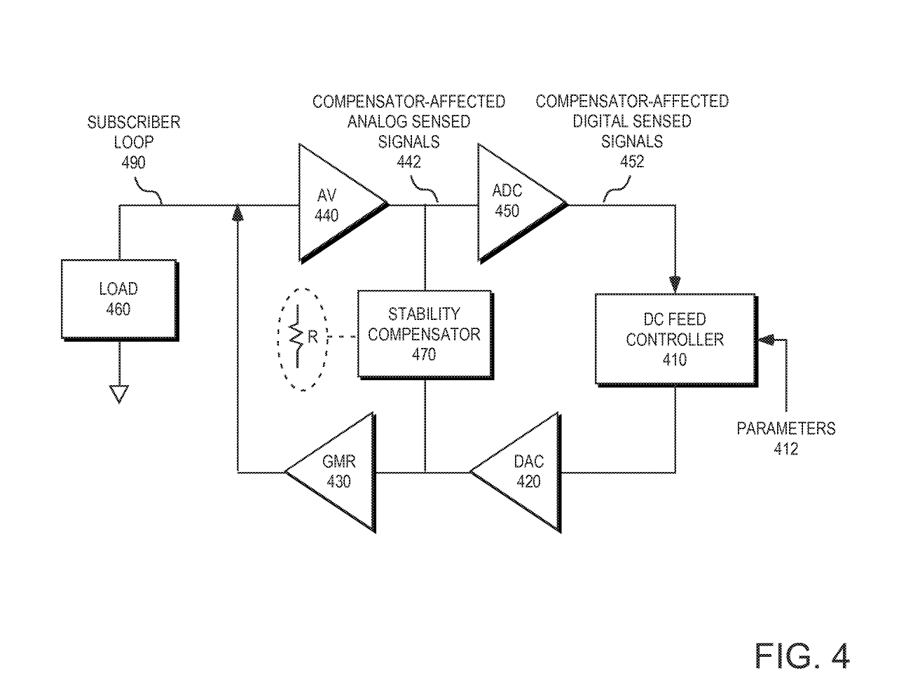

FIG. 4 illustrates one embodiment of a control loop including a stability compensator 470 for controlling the DC feed for a subscriber loop. DAC 420, GMR 430, AV 440, and ADC 450 otherwise perform the functions as set forth in FIG. 3. The stability compensator is provided to assure stability of the control loop. The stability compensator, for example, prevents the effective subscriber loop impedance from exceeding an impedance threshold such that the controller is not attempting to drive a high impedance subscriber load 460 on subscriber loop 490.

In one embodiment, the stability compensator is a passive element such as a resistor, R. The choice of value is bound by a few constraints. If the value is too low, then the stability compensator will consume too much of the current intended for the subscriber loop, thus needlessly consuming power. If the value is too high, then the stability compensator will not provide adequate stabilization of the control loop. In one embodiment, stability compensator 470 is a resistor R in a range of 3 kΩ-7 kΩ. In one embodiment, R is approximately 5 kΩ.

The tradeoff for stability for the illustrated voltage sensing/current feeding controller is that some of the current intended for the subscriber loop is diverted by the stability compensator 470. In FIG. 3, the sensed signals 342, 352 represent the subscriber loop signals 390. In FIG. 4, however, the sensed signals become compensator-affected representations of the signals from the subscriber loop 490. In particular, the analog sensed signals 442 and digital equivalent 452 are compensator-affected from their counterparts 342, 352 of the control loop of FIG. 3.

The introduction of the stability compensator thus alters the sensed signals provided to DC feed controller 410 and the resulting characteristic DC feed curve set forth in FIG. 2. In particular, controller 410 receives compensator-affected sensed signals 452. In order to counteract this effect, the controller 410 maps the first set of points defining a first DC feed curve to a second set of points defining a compensator-adjusted DC feed curve. For the voltage sensing, current feeding controller of FIG. 4, the points are mapped such that only current values change. In one embodiment, the points (P) are mapped as follows:

P₅₁₀→P₅₁₂; (0, V_{VLIM})→(V_{VLIM}/R,V_{VLIM})

P₅₂₀→P₅₂₂; (I_{RFEED}, V_{RFEED})→(I_{RFEED}+V_{RFEED}/R, V_{RFEED})

P₅₃₀→P₅₃₂; (I_{ILIM}, V_{ILIM})→(I_{ILIM}+V_{ILIM}/R, V_{ILIM})

P₅₄₀→P₅₄₀; (I_{ILIM}, 0)→(I_{LIM}, 0)

### The controller controls DC feed in accordance with the compensator-adjusted DC feed curve in response to the compensator-affected sensed subscriber loop signals such that the subscriber loop DC feed curve is the first DC feed curve.

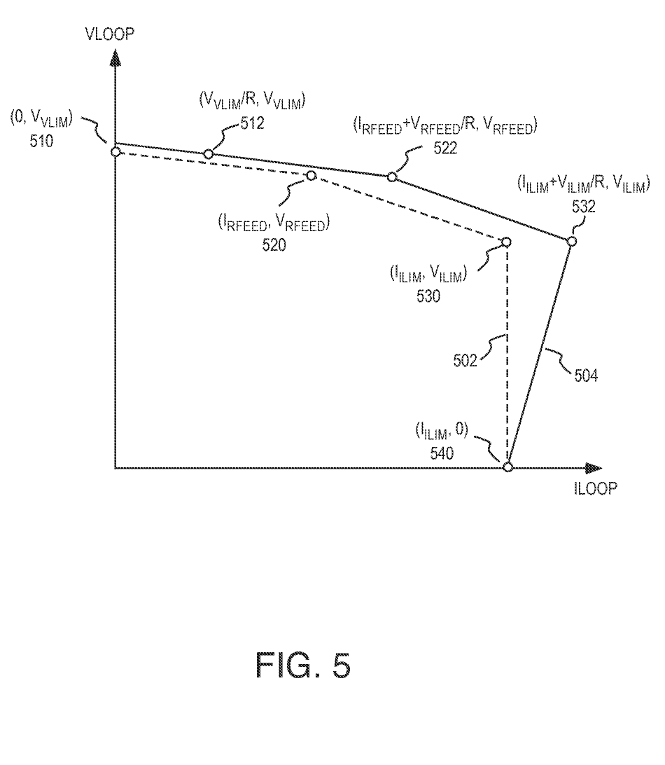

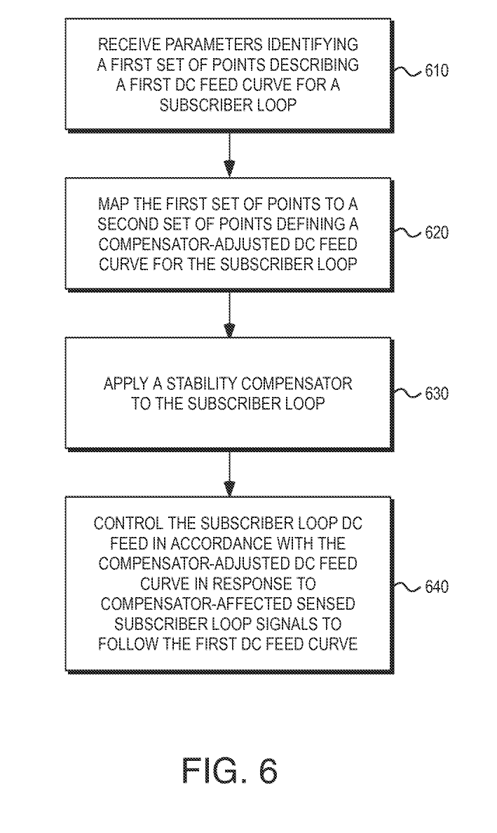

FIG. 5 illustrates the compensator-adjusted DC feed curve 504 superimposed upon the DC feed curve 502. FIG. 6 illustrates a method of digital control of the DC feed performed by DC feed controller 410. Referring to FIG. 6, parameters for identifying a first set of points defining a first DC feed curve for a subscriber loop are received in step 610. For the example of FIG. 5, the first set of points (α₁), may be defined as follows:

α₁={P₅₁₀P₅₂₀,P₅₃₀,P₅₄₀}

The first set of points are mapped to a second set of points defining a compensator-adjusted DC feed curve for the subscriber loop in step 620. For the example of FIG. 5, the mapping and second set of points (α₂), may be defined as follows:

α₁→α₂

α₂={P₅₁₂,P₅₂₂,P₅₃₂,P₅₄₀}

A stability compensator is applied to the subscriber loop in step 630. In step 640, the subscriber loop DC feed is controlled in accordance with the compensator-adjusted DC feed curve in response to compensator-affected sensed subscriber loop signals to follow the first DC feed curve.

With respect to the method of FIG. 6, the resistance of the stability compensator may be explicitly provided as one of the parameters or implicitly determined by design of the control loop. In one embodiment, the parameters include values for {V_{VLIM},I_{REED}, V_{RFEFD}, V_{ILIM},I_{ILIM}}. Additional parameters (e.g., R for the resistance of the stability compensator) may also be provided to the controller.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A subscriber line interface circuit apparatus comprising:
a controller for controlling a DC feed of a subscriber loop in accordance with a first DC feed curve defined by a first set of points in response to sensed subscriber loop signals; and
a stability compensator coupled to the subscriber loop, wherein the controller maps the first set of points to a second set of points to define a compensator-adjusted DC feed curve for compensator-affected sensed signals received from the subscriber loop, wherein the controller controls the DC feed in accordance with the compensator-adjusted DC feed curve in response to compensator-affected sensed subscriber loop signals such that the subscriber loop DC feed follows the first DC feed curve.

2. The apparatus of claim 1 wherein the controller is an integrated circuit signal processor.

3. The apparatus of claim 2 wherein the signal processor is fabricated as a complementary metal oxide semiconductor integrated circuit.

4. The apparatus of claim 1 wherein the controller receives parameters identifying the first set of points as (0, V_{VLIM}), (I_{RFEED}, V_{RFEED}), (I_{ILIM}, V_{ILIM}), (I_{ILIM}, 0).

5. The apparatus claim 4 wherein the second set of points is defined as (V_{VLIM}/R, V_{VLIM}), (I_{RFEED}+V_{VLIM}/R, V_{RFEED}), (I_{ILIM}+V_{ILIM}/R, V_{ILIM}), (I_{ILIM}, 0), wherein R is a resistance of the stability compensator.

6. The apparatus of claim 1 wherein the mapping from the first set of points to the second set of points alters current values.

7. The apparatus of claim 1 wherein the stability compensator is a resistor.

8. The apparatus of claim 7 wherein the resistor is in a range of 3 KΩ-7 KΩ.

9. The apparatus of claim 8 wherein the resistor is approximately 5KΩ.

10. The apparatus of claim 1 wherein the controller is a subscriber loop voltage sensing, current feeding controller.

11. A method comprising:
a) receiving parameters for identifying a first set of points defining a first DC feed curve for a subscriber loop;
b) mapping the first set of points to a second set of points defining a compensator-adjusted DC feed curve for the subscriber loop;
c) applying a stability compensator to the subscriber loop; and
d) controlling the subscriber loop DC feed in accordance with the compensator-adjusted DC feed curve in response to compensator-affected sensed subscriber loop signals to follow the first DC feed curve.

12. The method of claim 11 wherein the parameters identify the first set of points as {0, V_{VLIM}}, {I_{RFEED}, V_{RFEED}}, {I_{ILIM}, V_{ILIM}}, {I_{ILIM}, 0}.

13. The method of claim 12 wherein the second set of points is defined as {V_{VLIM}/R, V_{VLIM}}, {I_{RFEED}+V_{VLIM}/R, V_{RFEED}}, {I_{ILIM}+V_{ILIM}/R, V_{ILIM}}, {I_{ILIM}, 0}, wherein R is a resistance of the stability compensator.

14. The method of claim 11 wherein the mapping from the first set of parameters to the second set of parameters alters current values.

15. The method of claim 11 wherein the stability compensator is a resistor.

16. The method of claim 15 wherein the resistor is in a range of 3 KΩ-7 KΩ.

17. The method of claim 16 wherein the resistor is approximately 5KΩ.

18. The method of claim 11 wherein the step of controlling is performed by a subscriber loop voltage sensing, current feeding controller.

19. The method of claim 18 wherein the controller is an integrated circuit controller.

20. The method of claim 19 wherein the controller is fabricated as a complementary metal oxide semiconductor (CMOS) integrated circuit.
